(19) United States
(12) Patent Application Publication
(10) Pub. No.: US 2019/0184531 A1
(43) Pub. Date: Jun. 20, 2019

(54) HOSE CLAMP PLIERS

(71) Applicant: Ching-Shu Wang, Taichung City (TW)

(72) Inventor: Ching-Shu Wang, Taichung City (TW)

(21) Appl. No.: 15/843,610

(22) Filed: Dec. 15, 2017

(51) Int. Cl. B25B 25/00

(52) U.S. Cl. CPC B25B 25/005

(57) ABSTRACT

A hose clamp pliers includes a pliers assembly and a clamping device. The clamping device includes a first clamping element and a second clamping element. The second clamping element is movable with respect to the first clamping element for clamping. The first clamping element has a first stopping wall and a second stopping wall. The second clamping element has a third stopping wall and a fourth stopping wall. The first stopping wall and the third stopping wall face each other. The second stopping wall and the fourth stopping wall extend toward each other. The junction between the first stopping wall and the second stooping wall and the junction between the third stopping wall and the fourth stopping wall are adapted for the leg portions of the hose clamp to abut against.

### BACKGROUND OF THE INVENTION

### Field of the Invention

The present invention relates to a hose clamp pliers.

### Description of the Prior Art

A conventional hose clamp is ring-shaped and has two leg portions crossing each other. To loosen the hose clamp, the leg portions have to be moved toward each other by usually a clamping device.

Typical hose clamp pliers are shown in patents TW M253450, U.S. Pat. Nos. 6,634,258, and 6,736,031. The hose clamp pliers includes a pliers and a clamping device connected by a tube and a wire in the tube. The clamping device has two clamping elements which are movable with respect to each other. The two clamping elements are connected to the tube and the wire respectively. The two clamping elements are adapted for the leg portions of the hose clamp to abut against. When the wire is pulled by the pliers, the two clamping elements are moved toward each other to clamp the hose clamp so that the hose clamp is loosened.

However, it is difficult to put the leg portions of the hose clamp right on the two clamping elements in a narrow space. Besides, during the operation, the leg portions of the hose clamp may slip to move toward the spring biased between the two clamping elements so that the spring may be damaged, and that the operation fails.

In addition, the conventional clamping elements have complicated shapes and are difficult to manufacture. Also, the cost is high.

### SUMMARY OF THE INVENTION

The main object of the present invention is to provide a hose clamp pliers which is able to prevent the hose clamp from touching the spring and is able to clamp the hose clamp firmly.

To achieve the above and other objects, a hose clamp pliers of the present invention includes a pliers assembly and a clamping device.

The pliers assembly includes a first handle, a second handle, and a linkage bar assembly. The first handle has a first end and a second end. The second handle has a third end and a fourth end. The first handle is pivotally connected to the third end of the second handle with the first end thereof. The linkage bar assembly is pivotally arranged between the first handle and the second handle. The clamping device includes an outer tube, a wire, a first clamping element, and a second clamping element. An end of the outer tube is connected to the first end of the first handle, and an other end of the outer tube is connected to the first clamping element. The wire is inserted through the outer tube. Two ends of the wire extend exceeding two ends of the outer tube. One of the two ends of the wire is pivotally connected to the linkage bar assembly, and the other one of the two ends of the wire is inserted through the first clamping element to connect to the second clamping element. A spring is sleeved onto the wire to be biased between the first clamping element and the second clamping element so that the first clamping element and the second clamping element tend to move away from each other. A clamping space is defined between the first clamping element and the second clamping element. The first clamping element has a first stopping portion. The second clamping element has a second stopping portion. The first stopping portion includes a first stopping wall and a second stopping wall. The second stopping portion includes a third stopping wall and a fourth stopping wall. The first stopping wall and the third stopping wall face each other. The second stopping wall extends toward the second stopping portion. The fourth stopping wall extends toward the first stopping portion. A junction between the first stopping wall and the second stopping wall and a junction between the third stopping wall and the fourth stopping wall are adapted for two leg portions of a hose clamp to abut against respectively.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial breakdown drawing of the present invention;

FIG. 2 is a partial stereogram of the present invention;

FIG. 3 is a partial breakdown drawing of the present invention;

FIG. 4 is a partial lateral view of the present invention;

FIGS. 5 and 6 are illustrations of operation of the present invention.

### DETAILED DESCRIPTION OF THE PREFERRED EMBODIMENTS

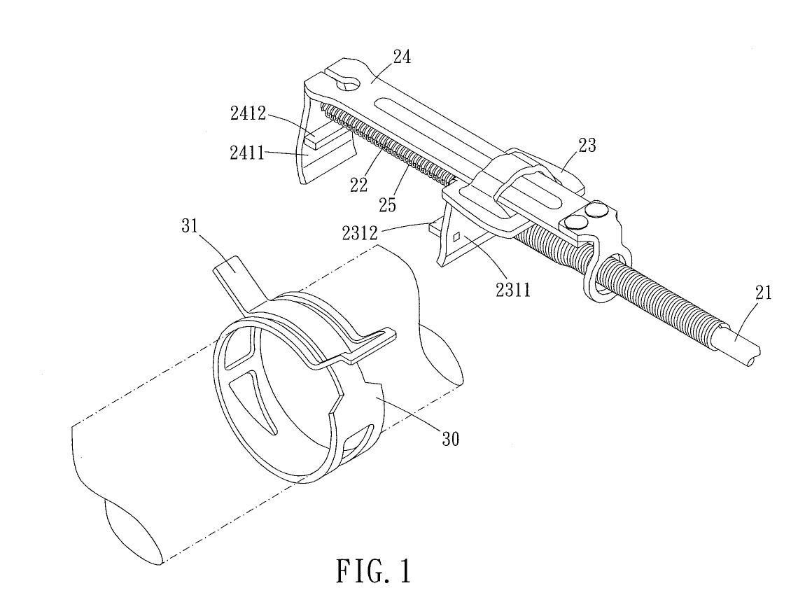

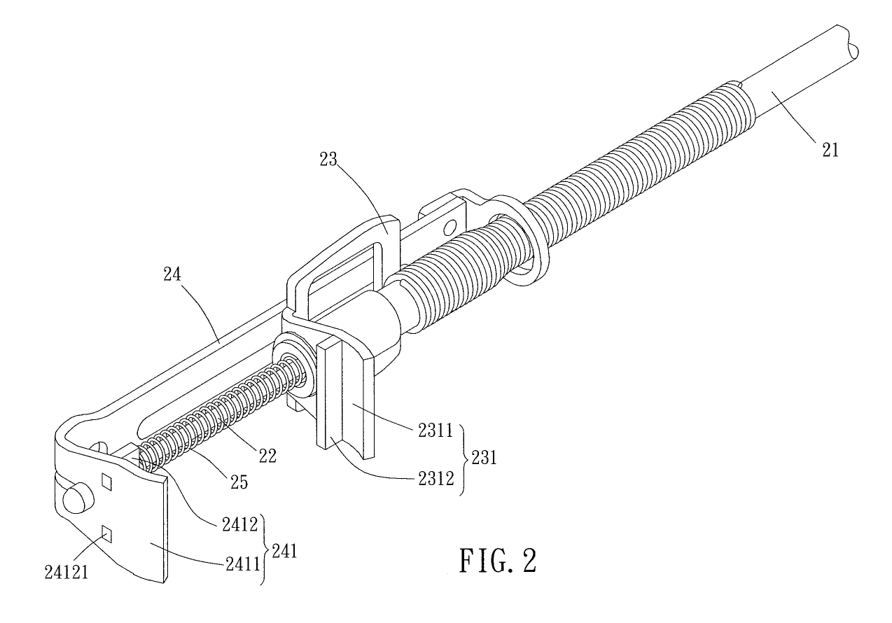

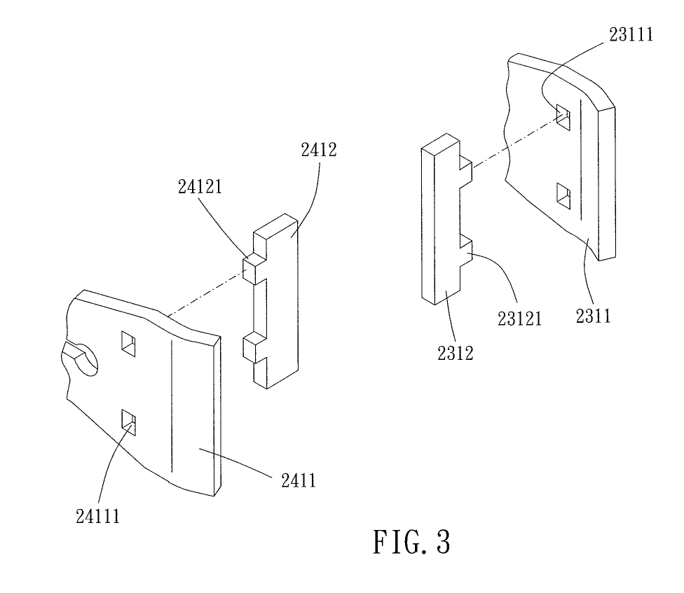

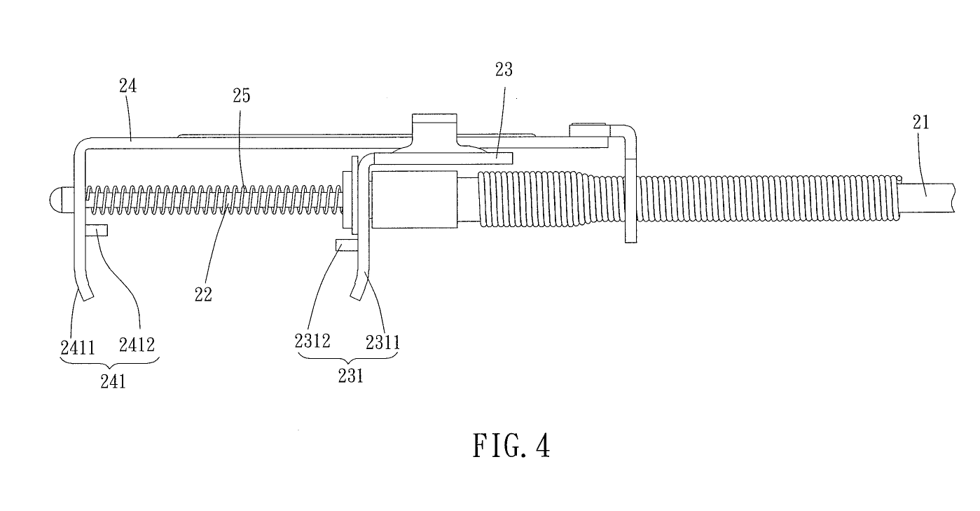

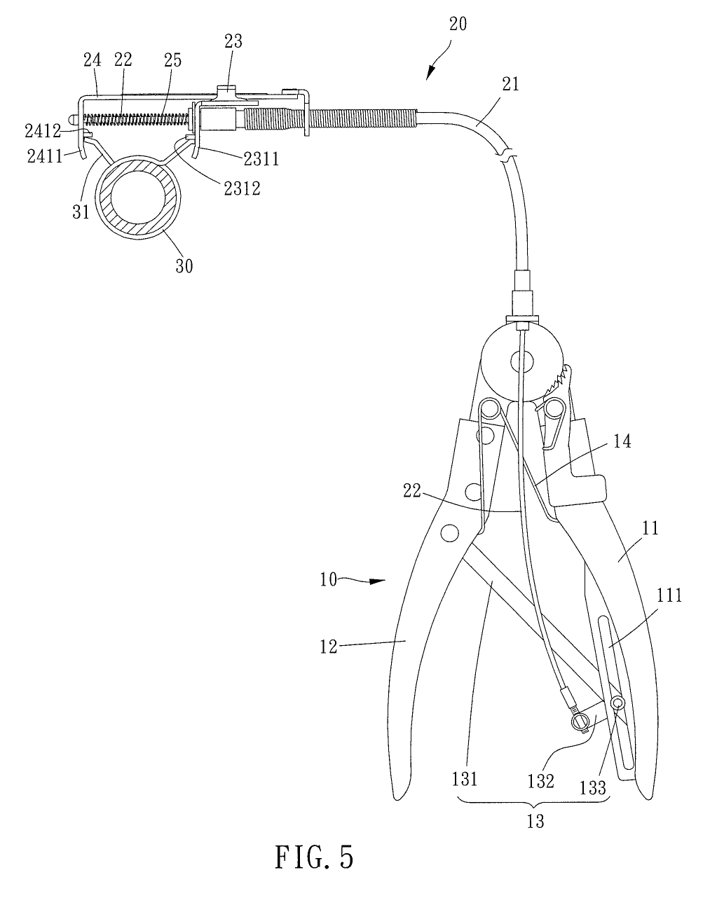

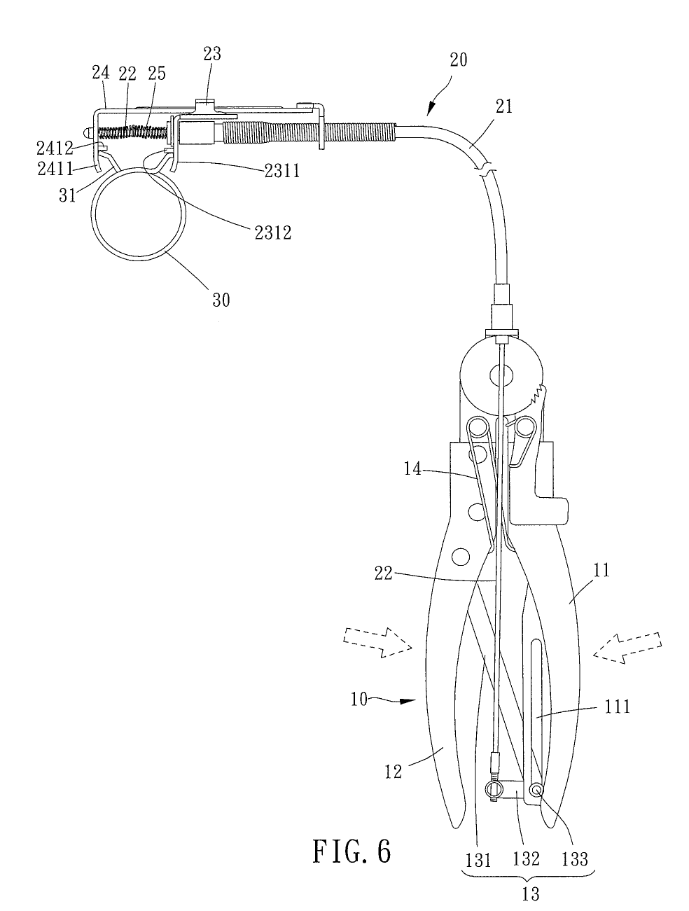

Please refer to FIG. 1 to FIG. 6, the hose clamp pliers of the present invention includes a pliers assembly 10 and a clamping device 20.

The pliers assembly 10 includes a first handle 11, a second handle 12, and a linkage bar assembly 13. The first handle 11 has a first end and a second end. The second handle 12 has a third end and a fourth end. The first handle 11 is pivotally connected to the third end of the second handle 12 with the first end thereof. The linkage bar assembly 13 is pivotally arranged between the first handle 11 and the second handle 12.

The clamping device 20 includes an outer tube 21, a wire 22, a first clamping element 23, and a second clamping element 24. An end of the outer tube 21 is connected to the first end of the first handle 11, and an other end of the outer tube 21 is connected to the first clamping element 11. The wire 22 is inserted through the outer tube 21. Two ends of the wire 22 extend exceeding two ends of the outer tube 21. One of the two ends of the wire 22 is pivotally connected to the linkage bar assembly 13, and the other one of the two ends of the wire 22 is inserted through the first clamping element 23 to connect to the second clamping element 24. A spring 25 is sleeved onto the wire 22 to be biased between the first clamping element 23 and the second clamping element 24 so that the first clamping element 23 and the second clamping element 24 tend to move away from each other. A clamping space is defined between the first clamping element 23 and the second clamping element 24. The first clamping element 23 has a first stopping portion 231. The second clamping element 24 has a second stopping portion 241. The first stopping portion 231 includes a first stopping wall 2311 and a second stopping wall 2312. The second stopping portion 241 includes a third stopping wall 2411 and a fourth stopping wall 2412. The first stopping wall 2311 and the third stopping wall 2411 face each other. The second stopping wall 2312 extends toward the second stopping portion 241. The fourth stopping wall 2412 extends toward the first stopping portion 231. A junction between the first stopping wall 2311 and the second stopping wall 2312 and a junction between the third stopping wall 2411 and the fourth stopping wall 2412 are adapted for two leg portions 31 of a hose clamp 30 to abut against respectively.

In the present embodiment, the first stopping wall 2311 and the third stopping wall 2411 are parallel to each other and both are perpendicular to an extending direction of the spring 25. The second stopping wall 2312 and the fourth stopping wall 2412 are parallel to the extending direction of the spring 25. That is, each of the first clamping element 23 and the second clamping element 24 is L-shaped. In addition, the first clamping element 23 and the second clamping element 24 have sections parallel to each other and slidably arranged. Thus, the movement path of the second clamping element 24 is restricted.

Specifically, the first stopping wall 2311 is formed with at least one aperture 23111, and the second stopping wall 2312 is formed with at least one protrusion 23121. The protrusion 23121 is inserted into the aperture 23111 in a tight-fit manner.

Similarly, the third stopping wall 2411 is formed with at least one aperture 24111, and the fourth stopping wall 2412 is formed with at least one protrusion 24121. The protrusion 24121 is inserted into the aperture 24111 in a tight-fit manner. As a result, the first clamping element 23 and the second clamping element 24 are easy to manufacture and assemble. Besides, the second stopping wall 2312 and the fourth stopping wall 2412 are staggered so that the second stopping wall 2312 and the fourth stopping wall 2412 never contact each other when the second clamp element 24 is moved toward the first clamp element 23.

In other possible embodiments, each of the first stopping portion and the second stopping portion can be a groove. The first and the third stopping walls are the bottom faces of the grooves, and the second and the fourth stopping walls are the lateral walls of the grooves opposite to the spring.

About the details of the linkage bar assembly 13, the linkage bar assembly 13 includes a long bar 131 and a short bar 132. The first handle 11 is formed with an elongated sliding groove 111 near the second end. One end of the long bar 131 is pivotally connected to an intermediate portion of the second handle 12, and an other end of the long bar 131 is pivotally connected to a sliding pin 133 which is slidably arranged in the sliding groove 111. One end of the short bar 132 is pivotally connected to the sliding pin 133, and an other end of the short bar 132 is pivotally connected to the wire 22. Besides, an elastic element 14 is biased between the first handle 11 and the second handle 12 so that the first handle 11 and the second handle 12 tend to move away from each other. Thereby, when gripping the first handle 11 and the second handle 12, the wire 22 is pulled back due to the linkage bar assembly 13, and the second clamping element 24 is pulled toward the first clamping element 23.

Generally, the hose clamp pliers is often used in a narrow space, so it is difficult to make the leg portions of the hose clamp positioned on the clamping device. In the present invention, the second stopping wall and the fourth stopping wall can prevent the leg portions of the hose clamp from touching the spring to damage it.

In addition, the first, the second, the third, and the fourth stopping walls are manufactured from metal sheets respectively, and the second and the fourth stopping walls are fixed to the first and the third stopping walls by tight-fit. Thus, the manufacture is extremely easy and quick, and the cost is reduced.

In conclusion, the second and the fourth stopping walls are able to block the leg portions of the hose clamp from moving toward the spring. Thus, the spring may not be damaged by the hose clamp. On the other hand, the clamping device is easy to manufacture and assemble so that the cost can be reduced.

What is claimed is:

1. A hose clamp pliers, including:
a pliers assembly, including a first handle, a second handle, and a linkage bar assembly, the first handle having a first end and a second end, the second handle having a third end and a fourth end, the first handle being pivotally connected to the third end of the second handle with the first end thereof, the linkage bar assembly being pivotally arranged between the first handle and the second handle;
a clamping device, including an outer tube, a wire, a first clamping element, and a second clamping element, an end of the outer tube being connected to the first end of the first handle, an other end of the outer tube being connected to the first clamping element, the wire being inserted through the outer tube, two ends of the wire extending exceeding two ends of the outer tube, one of the two ends of the wire being pivotally connected to the linkage bar assembly, the other one of the two ends of the wire being inserted through the first clamping element to connect to the second clamping element, a spring being sleeved onto the wire to be biased between the first clamping element and the second clamping element so that the first clamping element and the second clamping element tend to move away from each other, a clamping space being defined between the first clamping element and the second clamping element, the first clamping element having a first stopping portion, the second clamping element having a second stopping portion, the first stopping portion including a first stopping wall and a second stopping wall, the second stopping portion including a third stopping wall and a fourth stopping wall, the first stopping wall and the third stopping wall facing each other, the second stopping wall extending toward the second stopping portion, the fourth stopping wall extending toward the first stopping portion, a junction between the first stopping wall and the second stopping wall and a junction between the third stopping wall and the fourth stopping wall being adapted for two leg portions of a hose clamp to abut against respectively.

2. The hose clamp pliers of claim 1, wherein the first stopping wall and the third stopping wall are parallel to each other and both are perpendicular to an extending direction of the spring, the second stopping wall and the fourth stopping wall are parallel to the extending direction of the spring.

3. The hose clamp pliers of claim 2, wherein the first stopping wall is formed with at least one aperture, the second stopping wall is formed with at least one protrusion, the protrusion is inserted into the aperture in a tight-fit manner.

4. The hose clamp pliers of claim 2, wherein the third stopping wall is formed with at least one aperture, the fourth stopping wall is formed with at least one protrusion, the protrusion is inserted into the aperture in a tight-fit manner.

5. The hose clamp pliers of claim 2, wherein the second stopping wall and the fourth stopping wall are staggered so that the second stopping wall and the fourth stopping wall never contact each other when the second clamp element is moved toward the first clamp element.

6. The hose clamp pliers of claim 1, wherein the linkage bar assembly includes a long bar and a short bar, the first handle is folined with an elongated sliding groove near the second end, one end of the long bar is pivotally connected to an intermediate portion of the second handle, an other end of the long bar is pivotally connected to a sliding pin which is slidably arranged in the sliding groove, one end of the short bar is pivotally connected to the sliding pin, an other end of the short bar is pivotally connected to the wire.

7. The hose clamp pliers of claim 1, wherein an elastic element is biased between the first handle and the second handle so that the first handle and the second handle tend to move away from each other.

8. The hose clamp pliers of claim 1, wherein each of the first clamping element and the second clamping element is L-shaped, the first clamping element and the second clamping element have sections parallel to each other and slidably arranged.
